(19) United States
(12) Patent Application Publication
(10) Pub. No.: US 2026/0368574 A1
(43) Pub. Date: Nov. 19, 2026

(54) SIMULATOR, COMPUTER-READABLE RECORDING MEDIUM, AND SIMULATION SYSTEM

(71) Applicant: TOYOTA JIDOSHA KABUSHIKI KAISHA, Aichi-ken (JP)

(72) Inventors: Kei KAWASAKI, Funabashi-shi (JP); Yuta EZOE, Taito-ku (JP)

(21) Appl. No.: 19/678,158

(22) Filed: May 15, 2026

(30) Foreign Application Priority Data
May 19, 2025 (JP) 2025-083240

(51) Int. Cl. G06N 7/01

(52) U.S. Cl. CPC G06N 7/01

(57) ABSTRACT

A simulator performs an agent simulation. The simulator includes one or more processors. The one or more processors execute an initial setting process that communicates with an external system outside the simulator, acquires a probability of a next action of an agent calculated by the external system, and sets the next action represented by the probability as an initial state of the agent. After the initial setting process, the one or more processors execute a simulation process that simulates an action of the agent without using the external system.

### CROSS-REFERENCES TO RELATED APPLICATION

The present disclosure claims priority to Japanese Patent Application No. 2025-083240, filed on May 19, 2025, the contents of which application are incorporated herein by reference in their entirety.

### TECHNICAL FIELD

The present disclosure relates to a technique for performing an agent simulation.

### BACKGROUND ART

Patent Literature 1 discloses a traffic prediction device (simulator device) that predicts communication traffic. A user action model is an algorithmic representation of a movement action and a communication actions of a typical mobile user at the time of an event. The traffic prediction device simulates actions of users by using the user action model to predict a future communication traffic.

### List of Related Art

Patent Literature 1: Japanese Patent Application Publication No. 2017-208757

### SUMMARY

An agent simulation is considered. In an example, a simulator simulates an action of an agent by using an internal model. In order to improve accuracy of the simulation, it is necessary to improve performance of the internal model. However, when there are a large number of simulators independently, it takes a lot of time and efforts to improve the performance of the respective internal models of the large number of simulators.

In another example, a plurality of simulators may share a high-performance external system. Each simulator requests the external system to predict an action of an agent, and acquires a result of the prediction from the external system. However, in the case of this example, it is necessary to constantly exchange data between each simulator and the external system, which increases communication load. In particular, the communication load is increased as the number of agents being the simulation targets is increased.

A first aspect relates to a simulator for performing an agent simulation.

The simulator includes one or more processors.

The one or more processors are configured to:
execute an initial setting process that communicates with an external system outside the simulator, acquires a probability of a next action of an agent calculated by the external system, and sets the next action represented by the probability as an initial state of the agent; and
after the initial setting process, execute a simulation process that simulates an action of the agent without using the external system.

A second aspect relates to a simulation program executed by a computer to perform an agent simulation.

The simulation program, when executed, causes the computer to:
execute an initial setting process that communicates with an external system outside the computer, acquires a probability of a next action of an agent calculated by the external system, and sets the next action represented by the probability as an initial state of the agent; and
after the initial setting process, execute a simulation process that simulates an action of the agent without using the external system.

A third aspect relates to a simulation system.

The simulation system includes: a simulator configured to perform an agent simulation; and an external system outside the simulator.

The external system is configured to calculate a probability of a next action of an agent.

The simulator is configured to:
execute an initial setting process that communicates with the external system, acquires the probability of the next action of the agent, and sets the next action represented by the probability as an initial state of the agent; and
after the initial setting process, execute a simulation process that simulates an action of the agent without using the external system.

According to the present disclosure, the probability of the next action of the agent being the simulation target is calculated by the external system. Then, the next action represented by the calculated probability is set as the initial state of the agent. The simulator simulates the action of the agent based on the initial state. Improvement in performance of the external system leads to improvement in accuracy of the initial state of the agent, which results in improvement in accuracy of the simulation as well.

Moreover, the communication between the simulator and the external system occurs only during the initial setting process. During the execution of the simulation process after the initial setting process, the communication between the simulator and the external system is not required. Therefore, the communication load is significantly reduced.

That is, according to the present disclosure, it is possible to improve the simulation accuracy while suppressing the communication load.

### BRIEF DESCRIPTION OF DRAWINGS

FIG. 1 is a conceptual diagram for explaining an overview of an agent simulation;

FIG. 2 is a conceptual diagram for explaining a variety of forms of a common simulation system;

FIG. 3 is a block diagram illustrating an example of a configuration of a simulation system according to an embodiment;

FIG. 4 is a block diagram illustrating an example of a functional configuration of a simulation system according to an embodiment;

FIG. 5 is a block diagram showing an example of a configuration of a simulator according to an embodiment;

FIG. 6 is a block diagram illustrating an example of a configuration of an external system according to an embodiment;

FIG. 7 is a block diagram illustrating an example of a functional configuration of a simulation system according to an embodiment; and

FIG. 8 is a flowchart illustrating an example of processing performed by a simulation system according to an embodiment.

### DETAILED DESCRIPTION

Embodiments of the present disclosure will be described with reference to the accompanying drawings.

### 1. Agent Stimulation

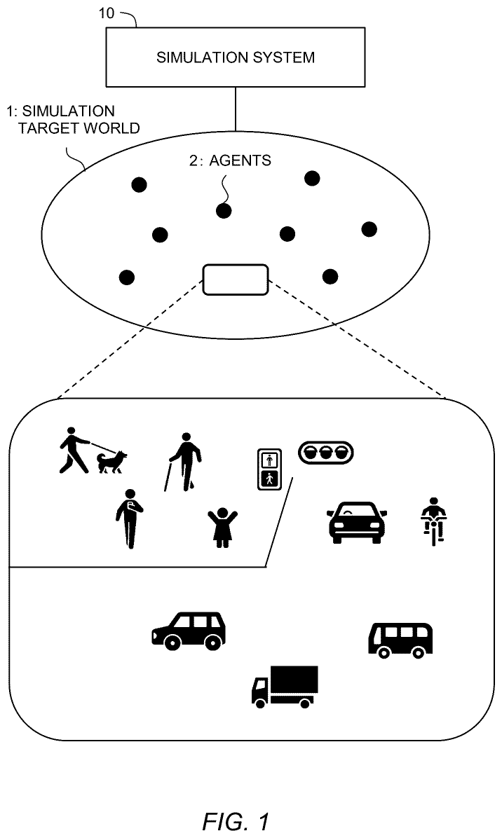

FIG. 1 is a conceptual diagram for explaining an overview of an agent simulation. A simulation target world 1 is a world to be subjected to the agent simulation. For example, the simulation target world 1 is a town, a building, or the like. The simulation target world 1 may be a world in which people coexist with vehicles and robots.

A wide variety of agents 2 exist in the simulation target world 1. For example, the agent 2 includes a moving body agent. Examples of the moving body agent include a person (pedestrian), a vehicle, a motor cycle, a bicycle, a robot, an animal, and the like. The agent 2 may include a stationary object agent whose state changes. Examples of the stationary object agent include a signal, an automatic door, and the like.

The agent 2 may have various attributes. For example, the attribute of a person being a type of the agent 2 is exemplified by age, gender, belongings, and the like. That is, the agent 2 may include a young person, an elderly person, a child, a person using a smartphone while walking, and the like. As another example, the attribute of a vehicle being another type of the agent 2 is exemplified by a vehicle type, a model, a usage, and the like. That is, the agent 2 may include a passenger car, a bus, a taxi, and the like.

A simulation system 10 is configured to simulate the agent 2 in the simulation target world 1. Typically, the simulation system 10 simultaneously simulates a plurality of agents 2. The simulation system 10 may perform the simulation while causing a plurality of agents 2 to interact with each other. Such the simulation is also called a multi-agent simulation.

In particular, the simulation system 10 is configured to simulate an “action” of the agent 2 in the simulation target world 1. Here, the action is a concept including a behavior, a movement, a selection, a state change, and the like. It is useful to simulate and predict the action of the agent 2 in the simulation target world 1. For example, a result of the prediction of the actions of the agents 2 can be used for traffic prediction, congestion prediction, risk prediction, power consumption prediction, purchase prediction, and the like. It is desirable to increase accuracy of the prediction of the action of the agent 2.

### 2. Problems Regarding Simulation System

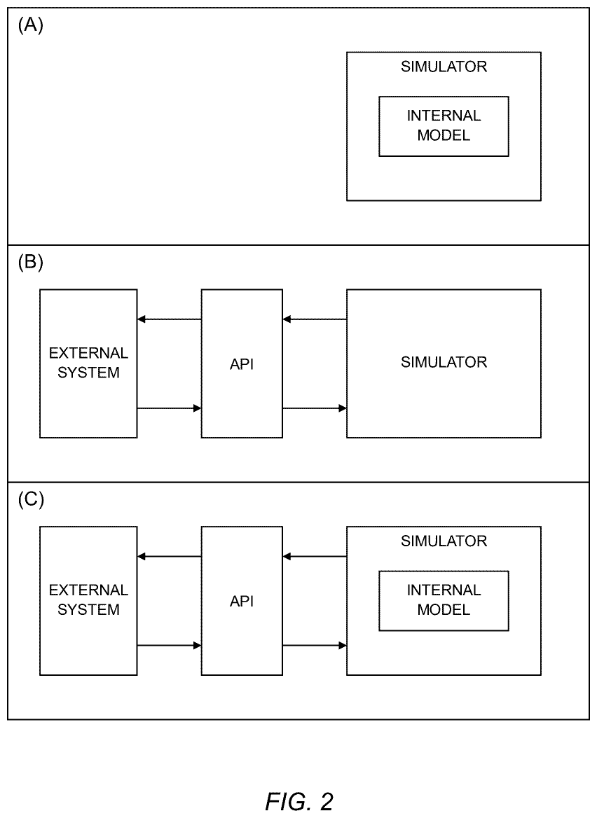

FIG. 2 is a conceptual diagram for explaining a variety of forms of a common simulation system. Problems regarding the common simulation system will be described with reference to FIG. 2.

In an example (A) in FIG. 2, a simulator includes an internal model (AI model) for simulating an action of an agent. The simulator performs the agent simulation by using the internal model. In order to improve accuracy of the simulation, it is necessary to improve the performance of the internal model. However, when there are a large number of simulators independently, it takes a lot of time and efforts to improve the performance of the respective internal models of the large number of simulators.

In an example (B) in FIG. 2, a simulator utilizes an external system. More specifically, the simulator requests the external system to predict an action of an agent via an application programming interface (API). The external system predicts the action of the agent requested by using an AI model. The simulator acquires a result of the prediction from the external system via the API. Improving the performance of the external system (AI model) makes it possible to improve the accuracy of the simulation. In this form, a plurality of simulators can share a high-performance external system. There is no need to individually improve the performance of each of the plurality of simulators. However, in this form, it is necessary to constantly exchange data between each simulator and the external system, which increases communication load. In particular, the communication load is increased as the number of agents being the simulation targets is increased. Furthermore, it is difficult to customize each simulator.

An example (C) in FIG. 2 is a combination of the example (A) and the example (B). The simulator includes an internal model (AI model) for simulating an action of an agent. In addition, the simulator can utilize the external system (i.e., external model) via the API. The simulator performs the agent simulation by using the internal model and the external system (i.e., external model) simultaneously in parallel. For example, the simulator makes some predictions by using the internal model and requests the external system for making other predictions. Since each simulator has the internal model, it is possible to customize each simulator. However, it remains still necessary to constantly exchange data between each simulator and the external system. Therefore, the communication load is increased. Furthermore, processing for synchronizing and matching a result of the prediction performed by the internal model with a result of the prediction performed by the external system becomes complicated.

### 3. Overview of Simulation System

From the above viewpoint, the present disclosure proposes a technique capable of improving the simulation accuracy while suppressing the communication load. The simulation system 10 according to an embodiment of the present disclosure is configured to improve the simulation accuracy while suppressing the communication load.

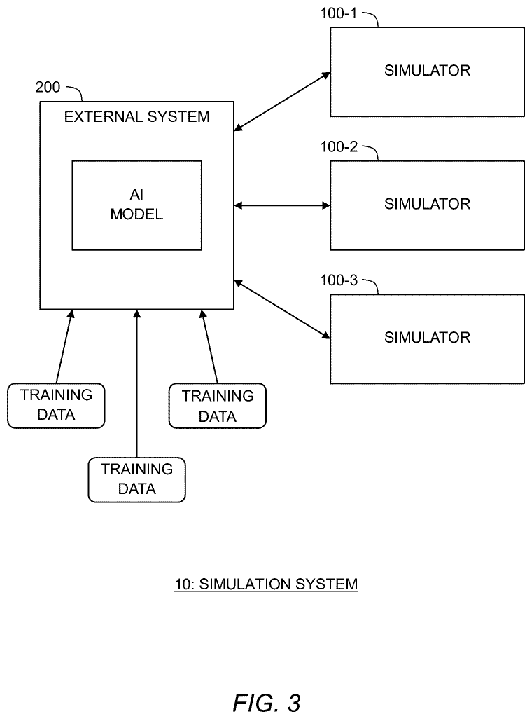

FIG. 3 is a block diagram illustrating an example of a configuration of the simulation system 10 according to the present embodiment. The simulation system 10 includes one or more simulators 100. The simulator 100 is a computer. The simulation system 10 may include a plurality of simulators 100. The plurality of simulators 100 may be used by different users.

The simulation system 10 further includes an external system 200 outside the simulator 100. The external system 200 provides a function related to the agent simulation. As will be described in detail later, the external system 200 particularly provides a function of calculating an “initial state” of the agent 2 in the agent simulation. Typically, the external system 200 includes an artificial intelligence (AI) model for providing the function related to the agent simulation. The AI model is trained based on a large amount of training data, and as a result, it is possible to utilize the high-performance AI model. That is, it is possible to utilize the high-performance external system 200.

Each simulator 100 can utilize the high-performance external system 200. That is, the plurality of simulators 100 can share the high-performance external system 200.

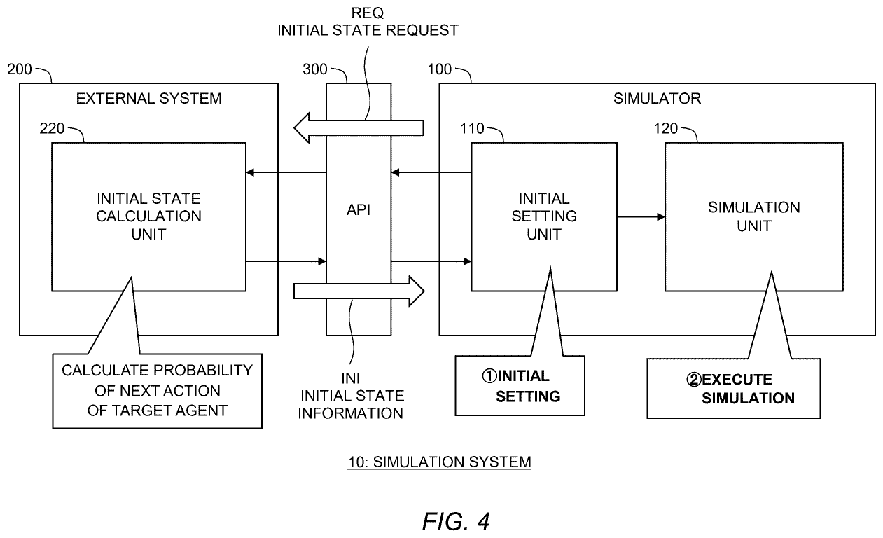

FIG. 4 is a block diagram illustrating an example of a functional configuration of the simulation system 10 according to the present embodiment. The simulator 100 and the external system 200 can communicate with each other via an application programming interface (API) 300.

The simulator 100 includes an initial setting unit 110 and a simulation unit 120.

The initial setting unit 110 performs an “initial setting process” that sets an initial state of an agent 2 being a simulation target (hereinafter, a target agent 2). More specifically, the initial setting unit 110 communicates with the external system 200 and requests the external system 200 to calculate the initial state of the target agent 2. An initial state request REQ is information for requesting calculation of the initial state of the target agent 2. For example, the initial state request REQ specifies a scene in which the initial state of the target agent 2 is to be calculated. The initial setting unit 110 transmits the initial state request REQ to the external system 200 via the API 300.

The external system 200 receives the initial state request REQ via the API 300. The external system 200 includes an initial state calculation unit 220. In response to the initial state request REQ, the initial state calculation unit 220 calculates a “probability” of a next action of the target agent 2. Typically, the initial state calculation unit 220 includes an AI model (external AI model) for calculating the probability of the next action, and calculates the probability of the next action of the target agent 2 by using the AI model. The next action represented by the probability is set as the initial state of the target agent 2.

For example, a scene in which the target agent 2 selects a transportation mode is considered. It is assumed that there are three types of options of the transportation mode, that is, public transportation, private car, and walking. The initial state calculation unit 220 calculates respective “probabilities” that the target agent 2 selects the public transportation, the private car, and the walking. It should be noted that the initial state calculation unit 220 does not definitely determine which of the public transportation, the private car, and the walking the target agent 2 selects. What the initial state calculation unit 220 calculates is merely the “probability” which is numerical information.

An initial state information INI indicates the probability of the next action of the target agent 2 calculated in this manner. The external system 200 returns the initial state information INI to the simulator 100 being the request source via the API 300.

The initial setting unit 110 acquires the initial state information INI from the external system 200 via the API 300. The initial state information INI indicates the probability of the next action of the target agent 2. The initial setting unit 110 sets the next action represented by the probability as the initial state of the target agent 2. Thus, the initial setting process is completed.

After the initial setting process is completed, the simulation unit 120 executes the agent simulation. That is, the simulation unit 120 simulates the action of the target agent 2 based on the set initial state. Typically, the simulation unit 120 includes an AI model (internal AI model) for simulating the action of the agent 2, and performs the agent simulation by using the AI model.

An example, the above-described scene in which the target agent 2 selects the transportation mode is considered. The simulation unit 120 simulates the action of the target agent 2 based on the respective probabilities that the target agent 2 selects the public transportation, the private car, and the walking. It is possible to simulate the action of the target agent 2 in various cases such as a case where a train is delayed, a case where the target agent 2 misses a train, and the like. Since it is not yet determined which of the public transportation, the private car, and the walking the target agent 2 selects, it is possible to execute the simulation of the target agent 2 with various logics in the simulator 100 (the simulation unit 120).

It should be noted here that the simulation unit 120 does not need to use the external system 200. The simulation unit 120 simulates the action of the target agent 2 without using the external system 200. That is, the simulation unit 120 executes the simulation process without communicating with the external system 200. During execution of the simulation process, no communication occurs between the simulator 100 and the external system 200. The communication between the simulator 100 and the external system 200 occurs only during the initial setting process. Therefore, the communication load required for the agent simulation is significantly reduced as compared with the cases of the comparative examples (B) and (C) shown in FIG. 2. As the number of target agents 2 increases, the effect of reduction the communication load becomes more remarkable.

Meanwhile, according to the present embodiment, the external system 200 calculates the probability of the next action of the target agent 2, and the result is set as the initial state of the target agent 2. The simulator 100 simulates the action of the target agent 2 based on the initial state. Improvement in performance of the external system 200 leads to improvement in accuracy of the initial state of the target agent 2, which results in improvement in accuracy of the simulation as well.

That is, according to the present embodiment, it is possible to improve the simulation accuracy while suppressing the communication load.

### 4. Concrete Examples of Simulation System

Hereinafter, a concrete example of the simulation system 10 according to the present embodiment will be described. 4-1. Configuration Example of Simulator

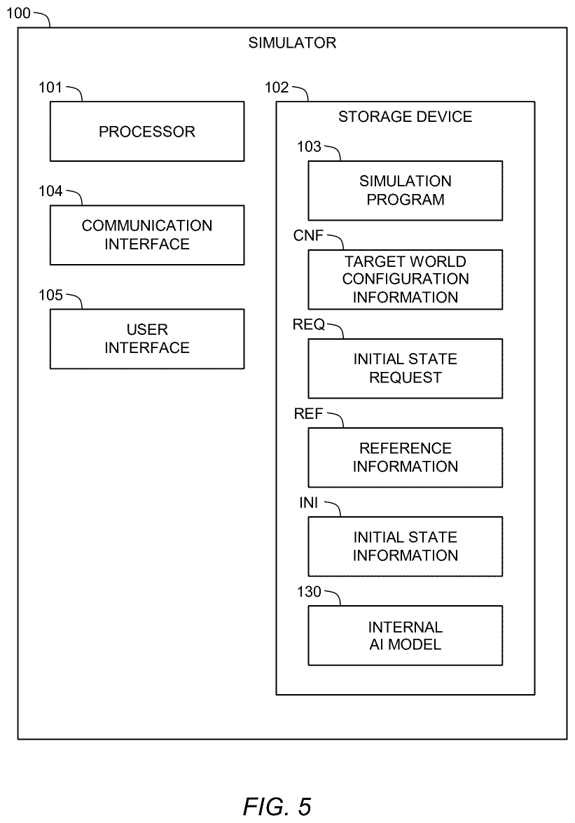

FIG. 5 is a block diagram illustrating an example of a configuration of the simulator 100 according to the present embodiment.

The simulator 100 includes one or more processors 101 (hereinafter simply referred to as a processor 101) and one or more storage devices 102 (hereinafter simply referred to as a storage device 102). The processor 101 executes a variety of processing. Examples of the processor 101 include a general-purpose processor, a special-purpose processor, a central processing unit (CPU), a graphics processing unit (GPU), an application specific integrated circuit (ASIC), a field-programmable gate array (FPGA), and the like. The processor 101 may also be referred to as processing circuitry. The storage device 102 stores a variety of information. Examples of the storage device 102 include a volatile memory, a nonvolatile memory, a hard disk drive (HDD), a solid state drive (SSD), and the like.

A simulation program 103 is a computer program executed by the processor 101. The functions of the simulator 100 may be realized by a cooperation of the processor 101 executing the simulation program 103 and the storage device 102. The simulation program 103 is stored in the storage device 102. Alternatively, the simulation program 103 may be recorded on a non-transitory computer-readable recording medium.

The simulator 100 further includes a communication interface 104 for communicating with the outside. For example, the processor 101 communicates with the external system 200 via the communication interface 104. As another example, the processor 101 may communicate with an information providing system (e.g., a traffic information service system, a weather information service system, and the like) via the communication interface 104. As still another example, the processor 101 may communicate with an infrastructure camera installed in the simulation target world 1.

The simulator 100 may further include a user interface 105 for receiving information from a user and providing information to a user. The user interface 105 includes an input device and an output device. Examples of the input device include a touch panel, a keyboard, a button, a microphone, and the like. Examples of the output device include a display device, a touch panel, a speaker, and the like. The processor 101 is able to receive condition information related to the agent simulation from the user via the user interface 105. In addition, the processor 101 is able to present the results of the agent simulation to the user via the user interface 105.

The storage device 102 stores target world configuration information CNF, the initial state request REQ, reference information REF, the initial state information INI, an internal AI model 130, and the like.

The target world configuration information CNF indicates a configuration of the simulation target world 1. The configuration of the simulation target world 1 includes an arrangement of objects constituting the simulation target world 1. The objects constituting the simulation target world 1 include buildings, rooms, doors, roads, walls, trees, and the like. For example, the target world configuration information CNF is created in advance by an administrator and stored in the storage device 102.

As described above, the initial state request REQ is information for requesting calculation of the initial state of the target agent 2. For example, the initial state request REQ specifies a scene in which the initial state of the target agent 2 is to be calculated. In the initial setting process, the processor 101 transmits the initial state request REQ to the external system 200 via the communication interface 104.

The reference information REF, which is related to the target agent 2, is information that is referred to in calculation of the initial state of the target agent 2. In the initial setting process, the processor 101 provides (transmits) the reference information REF to the external system 200 via the communication interface 104.

For example, the reference information REF includes attribute information indicating an attribute of the target agent 2. For example, the attribute of a person being a type of the target agent 2 is exemplified by age, gender, belongings, and the like. As another example, the attribute of a vehicle being another type of the agent 2 is exemplified by a vehicle type, a model, a usage, and the like. The attribute information may include information on a persona (personality) of the target agent 2. For example, the persona of a person being a type of the target agent 2 is exemplified by extrovert, introvert, optimistic, pessimistic, and the like. The attribute information is created in advance by the administrator.

As another example, the reference information REF may include environment information indicating an environment in which the target agent 2 is placed. Examples of the environment in which the target agent 2 is placed include weather, season, hours of day, traffic condition, congestion level, and the like. The information on the weather is obtained from the weather information service system or an image captured by an infrastructure camera installed in the simulation target world 1. The information on the season and hours of day is obtained from a system clock. The information on the traffic condition is obtained from the traffic information service system or an image captured by an infrastructure camera installed in the simulation target world 1. The information on the congestion level is obtained from an image captured by an infrastructure camera installed in the simulation target world 1. The environment information may include the target world configuration information CNF around the target agent 2.

As described above, the initial state information INI is information indicating the probability of the next action of the target agent 2. The initial state information INI is generated by the external system 200. In the initial setting process, the processor 101 receives the initial state information INI from the external system 200 via the communication interface 104.

The internal AI model 130 is an AI model for simulating the action of the agent 2. The internal AI model 130 is generated in advance through machine learning. It should be noted that the internal AI model 130 may be designed in any manner. The internal AI model 130 is designed as appropriate by a user of the simulator 100.

### 4-2. Configuration Example of External System

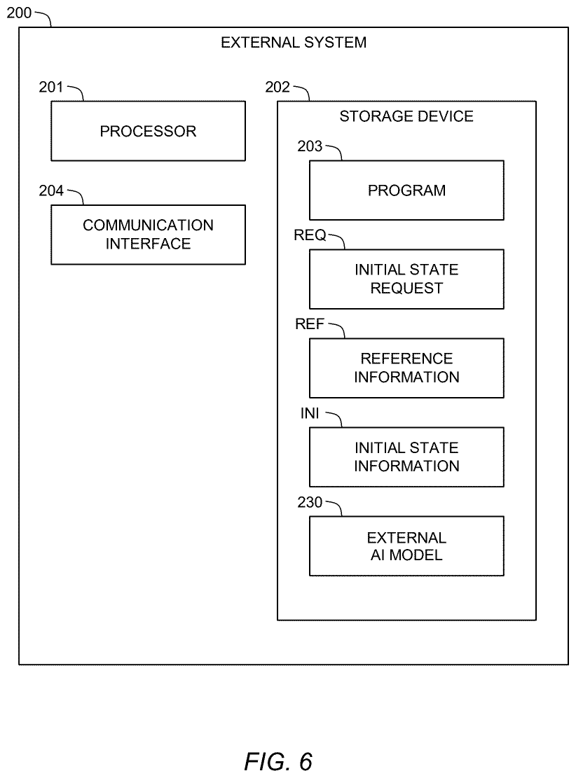

FIG. 6 is a block diagram illustrating an example of a configuration of the external system 200 according to the present embodiment.

The external system 200 includes one or more processors 201 (hereinafter, simply referred to as a processor 201) and one or more storage devices 202 (hereinafter, simply referred to as a storage device 202). The processor 201 executes a variety of processing. Examples of the processor 201 include a general-purpose processor, a special-purpose processor, a CPU, a GPU, an ASIC, an FPGA, and the like. The processor 201 may also be referred to as processing circuitry. The storage device 202 stores a variety of information. Examples of the storage device 202 include a volatile memory, a nonvolatile memory, an HDD, an SSD, and the like.

A program 203 is a computer program executed by the processor 201. The functions of the external system 200 may be realized by a cooperation between the processor 201 executing the program 203 and the storage device 202. The program 203 is stored in the storage device 202. Alternatively, the program 203 may be recorded on a non-transitory computer-readable recording medium.

The external system 200 further includes a communication interface 204 for communicating with the outside. For example, the processor 201 communicates with the simulator 100 via the communication interface 204. As another example, the processor 201 may communicate with an information providing system (e.g., a traffic information service system, a weather information service system, and the like) through the communication interface 204. As still another example, the processor 201 may communicate with an infrastructure camera installed in the simulation target world 1.

The storage device 202 stores the initial state request REQ, the reference information REF, the initial state information INI, an external AI model 230, and the like.

As described above, the initial state request REQ is information for requesting calculation of the initial state of the target agent 2. For example, the initial state request REQ specifies a scene in which the initial state of the target agent 2 is to be calculated. In the initial setting process, the processor 201 receives the initial state request REQ from the simulator 100 via the communication interface 204.

As described above, the reference information REF is information related to the target agent 2, and is information that is referred to in the calculation of the initial state of the target agent 2. The processor 201 receives the reference information REF from the simulator 100 via the communication interface 204. The processor 201 may acquire the environment information of the reference information REF from the information providing system or the infrastructure camera.

As described above, the initial state information INI is information indicating the probability of the next action of the target agent 2. The processor 201 transmits the initial state information INI to the simulator 100 via the communication interface 204.

The external AI model 230 is an AI model for calculating the probability of the next action of the target agent 2. The external AI model 230 is generated in advance through machine learning. A high-performance external AI model 230 is generated by machine learning based on a large amount of training data.

### 4-3. Example of Functional Configuration

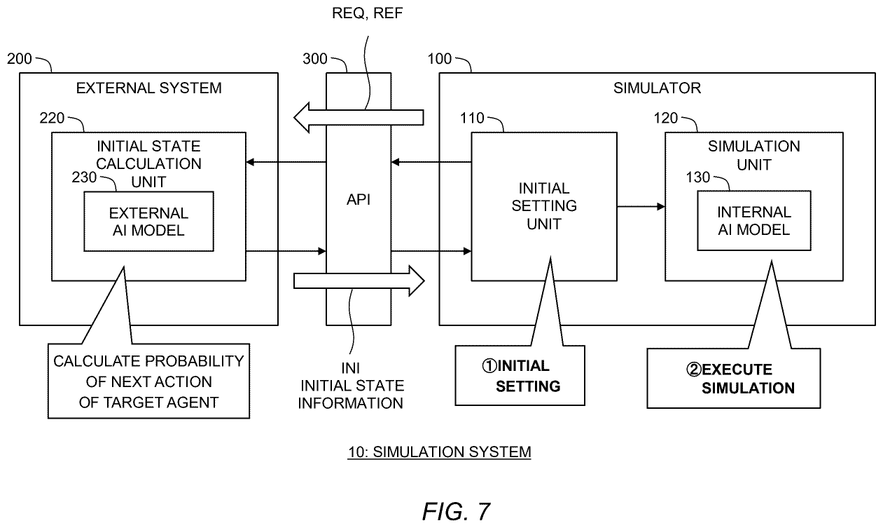

FIG. 7 is a block diagram illustrating an example of a functional configuration of the simulation system 10 according to the present embodiment.

The simulator 100 includes the initial setting unit 110 and the simulation unit 120 as functional blocks. The initial setting unit 110 executes the initial setting process that sets the initial state of the target agent 2. The simulation unit 120 executes the simulation process that simulates the action of the target agent 2. The simulation unit 120 includes the internal AI model 130 described above. The initial setting unit 110 and the simulation unit 120 are realized by a cooperation of the processor 101 and the storage device 102.

The external system 200 includes the initial state calculation unit 220 as a functional block. The initial state calculation unit 220 calculates the probability of the next action of the target agent 2. The initial state calculation unit 220 includes the external AI model 230 described above. The initial state calculation unit 220 is realized by a cooperation of the processor 201 and the storage device 202.

### 4-4. Example of Processing Flow

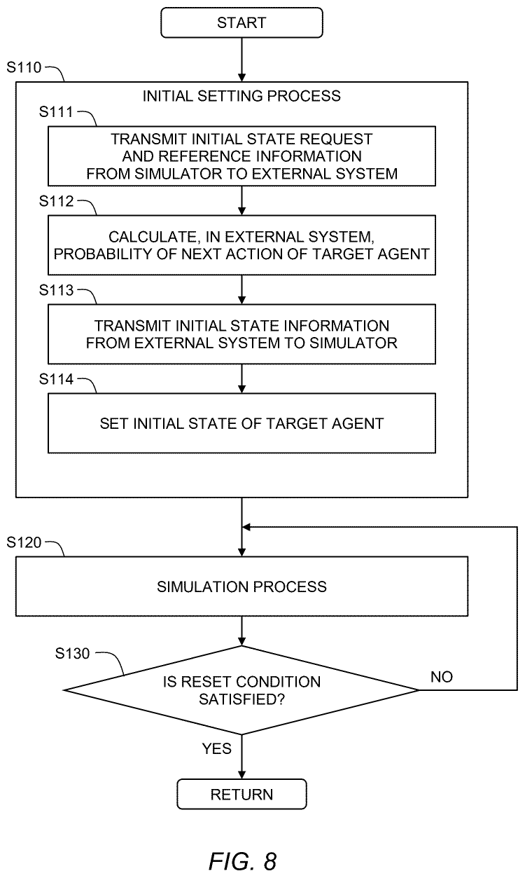

FIG. 8 is a flowchart illustrating an example of processing performed by the simulation system 10 according to the present embodiment.

### 4-4-1. Initial Setting Process (Step S110)

In Step S110, the initial setting unit 110 performs the initial setting process that sets the initial state of the target agent 2 being the simulation target.

More specifically, in Step S111, the initial setting unit 110 communicates with the external system 200 and transmits the initial state request REQ to the external system 200. The initial setting unit 110 transmits (provides) the reference information REF to the external system 200 together with the initial state request REQ.

In Step S112, the initial state calculation unit 220 of the external system 200 receives the initial state request REQ and the reference information REF. In response to the initial state request REQ, the initial state calculation unit 220 calculates the probability of the next action of the target agent 2. More specifically, the initial state calculation unit 220 calculates the probability of the next action of the target agent 2 by using the external AI model 230. At this time, the initial state calculation unit 220 calculates the probability of the next action of the target agent 2 based on the reference information REF regarding the target agent 2. Considering the reference information REF regarding the target agent 2 makes it possible to further improve the accuracy of calculation of the probability of the next action of the target agent 2.

In Step S113, the initial state calculation unit 220 transmits the initial state information INI indicating the probability of the next action of the target agent 2 to the simulator 100 being the request source.

In Step S114, the initial setting unit 110 acquires the initial state information INI from the external system 200. The initial state information INI indicates the probability of the next action of the target agent 2. The initial setting unit 110 sets the next action represented by the probability as the initial state of the target agent 2.

Thereafter, the processing proceeds to Step S120.

### 4-4-2. Simulation Process (Step S120)

In Step S120, the simulation unit 120 of the simulator 100 executes the agent simulation. That is, the simulation unit 120 simulates the action of the target agent 2 based on the set initial state. More specifically, the simulation unit 120 simulates the action of the target agent 2 by using the internal AI model 130. It should be noted that during Step S120, the simulation unit 120 executes the simulation process without using the external system 200 and without communicating with the external system 200.

### 4-4-3. Reset Condition Determination Process

In Step S130, the simulator 100 determines whether or not a reset condition is satisfied.

A first example of the reset condition is that a predetermined time has elapsed since last execution of the initial setting process (Step S110).

A second example of the reset condition is that the result of the simulation process (Step S120) is not good. More specifically, the simulator 100 calculates a degree of deviation between the action of the target agent 2 obtained by the simulation process (Step S120) and an actual action of the target agent 2. The actual action of the target agent 2 is recognized based on, for example, an image captured by an infrastructure camera installed in the simulation target world 1. The simulator 100 recognizes the actual action of the target agent 2 by analyzing the image captured by the infrastructure camera. When the action of the target agent 2 obtained by the simulation process matches the actual action of the target agent 2, the degree of deviation is calculated to be relatively low. On the other hand, when the action of the target agent 2 obtained by the simulation process does not match the actual action of the target agent 2, the degree of deviation is calculated to be relatively high. The second example of the reset condition is that the degree of deviation exceeds a predetermined threshold value.

When the reset condition is not satisfied (Step S130; No), the processing returns to Step S120. That is, the simulation process (Step S120) continues.

On the other hand, when the reset condition is satisfied (Step S130; Yes), the processing returns to Step S110, and the initial setting process is executed again. As a result, the simulation accuracy is maintained.

### 5. Effects

According to the present embodiment, the probability of the next action of the target agent 2 is calculated by the external system 200. Then, the next action represented by the calculated probability is set as the initial state of the target agent 2. The simulator 100 simulates the action of the target agent 2 based on the initial state. Improvement in performance of the external system 200 leads to improvement in accuracy of the initial state of the target agent 2, which results in improvement in accuracy of the simulation as well.

Moreover, the communication between the simulator 100 and the external system 200 occurs only during the initial setting process. During the simulation process after the initial setting process, the communication between the simulator 100 and the external system 200 is not required. Therefore, the communication load required for the agent simulation is significantly reduced as compared with the cases of the comparative examples (B) and (C) shown in FIG. 2. As the number of target agents 2 increases, the effect of reduction the communication load becomes more remarkable.

That is, according to the present embodiment, it is possible to improve the simulation accuracy while suppressing the communication load.

In addition, unlike the case of the comparative example (C) in FIG. 2, it is not necessary to synchronize or match a result of the prediction performed by the internal AI model 130 with a result of the prediction performed by the external AI model 230. This also contributes to the reduction in load.

The effect of the present embodiment becomes more remarkable as the number of target agents 2 increases. Even the multi-agent simulation at a city level can be executed with a low load.

What is claimed is:

1. A simulator for performing an agent simulation,
the simulator comprising processing circuitry configured to:
execute an initial setting process that communicates with an external system outside the simulator, acquires a probability of a next action of an agent calculated by the external system, and sets the next action represented by the probability as an initial state of the agent; and
after the initial setting process, execute a simulation process that simulates an action of the agent without using the external system.

2. The simulator according to claim 1, wherein
in the initial setting process, the processing circuitry is configured to:
provide the external system with reference information on the agent; and
acquires the probability of the next action of the agent calculated by the external system based on the reference information.

3. The simulator according to claim 2, wherein
the reference information includes attribute information indicating an attribute of the agent.

4. The simulator according to claim 2, wherein
the reference information includes environment information indicating an environment in which the agent is placed.

5. The simulator according to claim 1, further comprising one or more storage devices configured to store an internal AI model configured to simulate an action of an agent, wherein
the processing circuitry is configured to execute the simulation process by using the internal AI model.

6. The simulator according to claim 1, wherein
the external system is configured to calculate the probability of the next action of the agent by using an external AI model.

7. The simulator according to claim 1, wherein
the processing circuitry is further configured to:
when a reset condition is satisfied, stop the simulation process, execute the initial setting process again, and then execute the simulation process again.

8. The simulator according to claim 7, wherein
the reset condition is that a predetermined time elapses since last execution of the initial setting process.

9. The simulator according to claim 7, wherein
the processing circuitry is further configured to calculate a degree of deviation between the action of the agent obtained by the simulation process and an actual action of the agent, and
the reset condition is that the degree of deviation exceeds a threshold value.

10. A non-transitory computer-readable recording medium on which a simulation program for perming an agent simulation is recorded,
the simulation program, when executed by a computer, causing the computer to:
execute an initial setting process that communicates with an external system outside the computer, acquires a probability of a next action of an agent calculated by the external system, and sets the next action represented by the probability as an initial state of the agent; and
after the initial setting process, execute a simulation process that simulates an action of the agent without using the external system.

11. A simulation system comprising:
a simulator configured to perform an agent simulation; and
an external system outside the simulator, wherein
the external system is configured to calculate a probability of a next action of an agent,
the simulator is configured to:
execute an initial setting process that communicates with the external system, acquires the probability of the next action of the agent, and sets the next action represented by the probability as an initial state of the agent; and
after the initial setting process, execute a simulation process that simulates an action of the agent without using the external system.

12. The simulation system according to claim 11, wherein
the external system communicates with a plurality of simulators and is shared by the plurality of simulators.
